(19) United States
(12) Patent Application Publication
(10) Pub. No.: US 2006/0080801 A1
(43) Pub. Date: Apr. 20, 2006

(54) Vacuum cleaning system for a vehicle

(76) Inventor: Jerry L. Nameth, Dubuque, IA (US)

Correspondence Address: JAMES RAY & ASSOCIATES, 2640 PITCAIRN ROAD, MONROEVILLE, PA, 15146, US

(21) Appl. No.: 11/252,235

(22) Filed: Oct. 17, 2005

Related U.S. Application Data
(60) Provisional application No. 60/620,124, filed on Oct. 19, 2004.

(51) Int. Cl. B60S 1/64

(52) U.S. Cl. 15/313

(57) ABSTRACT

A vacuum cleaning system for a motor vehicle includes an inlet port disposed in a predetermined portion of an interior passenger cabin and an outlet port disposed in a predetermined portion of a cargo area of such vehicle and which are connected therebetween with a conduit. A suction generating assembly is disposed within the cargo area and includes a housing attached to a floor member of the cargo area. The housing has an intake opening aligned with the outlet port and an exhaust opening disposed on an outer surface of the housing and which are connected therebetween by a passageway. A waste collection container is removably disposed within the housing intermediate the intake and the exhaust openings. A flexible hose engages the inlet port for vacuum cleaning the interior passenger cabin.

### CROSS-REFERENCE TO RELATED APPLICATIONS

This application is related to and claims priority from a provisional patent application Ser. No. 60/620,124 filed on Oct. 19, 2004.

### FIELD OF THE INVENTION

The present invention relates, in general, to a vacuum cleaning system for use in a motor vehicle and, more particularly, this invention relates to a vacuum cleaning system for use in a motor vehicle which provides for convenience in cleaning passenger cabin, cargo area and which can be utilized external to the vehicle confines.

### BACKGROUND OF THE INVENTION

Vacuum cleaning systems for a motor vehicle are well known in the prior art. For example, U.S. Pat. No. 5,189,753 to Sousa et al discloses a truck mounted vacuum cleaner, which is formed by a waste collection chamber and an air withdrawal chamber, and which are removably attached together with a snap means. A baffle is used to direct the waste into the waste collection chamber and prevent such waste from entering the air withdrawal chamber. A cup shaped filter element slides over a filter support member, which is attached to the fan assembly disposed in the air withdrawal chamber and must be removed for cleaning after detachment and removal of the waste collection chamber. A hose connector is provided in the wall, or the bulkhead, separating the trunk area from the vehicle interior. Such attachment of the filter element is undesirable as dust particles are released into the trunk area during handling.

U.S. Pats. Nos. 6,813,805 and 6,490,751 both to Ganzenmiller disclose a direct port vacuum cleaning system which does not require piping throughout the vehicle. The system includes a removable debris connector connected to the vacuum generating unit. The vacuum cleaner hose is directly connected to the removable debris container. An inverter provides 110 volts of power to the vacuum cleaning system from a vehicle battery source thus increasing complexity and cost of the system.

U.S. Pub. No. 2004/0134013 to Slone discloses a vacuum cleaner assembly with suction nozzle and controls located within a reach zone of the driver sitting in the driver seat. Such vacuum cleaner assembly requires a greater effort to clean the trunk or cargo area of the vehicle.

Additionally, the aforementioned vacuum cleaning systems require use of a hose assembly and do not provide ease of cleaning external to the vehicle confines.

### SUMMARY OF THE INVENTION

The present invention provides a vacuum cleaning system for a motor vehicle. Such vacuum cleaning system includes an inlet port disposed in a predetermined portion of an interior passenger cabin and an outlet port disposed in a predetermined portion of a cargo area of such vehicle. The inlet and outlet ports are connected therebetween with a conduit. A suction generating assembly is disposed within the cargo area. According to one aspect of the invention, the suction generating assembly includes a housing attached to a floor member of the cargo area. The housing has an intake opening aligned with the outlet port and an exhaust opening disposed on an outer surface of the housing. Such intake and exhaust openings are connected therebetween by a passageway. A waste collection container is removably disposed within the housing intermediate the intake and the exhaust openings. A flexible hose engages the inlet port for vacuuming the interior passenger cabin.

According to another aspect of the invention, the suction generating assembly includes a base member attached to the floor member of the cargo area. Such base member has a cradle with an intake end aligned with the outlet port and at least one electrical contact connected to a battery source of the vehicle. A rechargeable cordless vacuum cleaner is at least partially secured and removably received in the cradle. The rechargeable cordless vacuum cleaner has a nozzle with one end securely received by the intake end of the base member and at least one second electrical contact cooperating with the at least one first electrical contact to recharge a rechargeable battery when the rechargeable cordless vacuum cleaner is secured in the cradle.

According to yet another aspect of the invention, such vacuum cleaning system includes a base member attached to the floor member of the cargo area. Such base member has a cradle with at least one electrical contact connected to a battery source of the vehicle. A rechargeable cordless vacuum cleaner is at least partially secured and removably received in the cradle. The rechargeable cordless vacuum cleaner has a nozzle and at least one second electrical contact cooperating with the at least one first electrical contact to recharge a rechargeable battery when the rechargeable cordless vacuum cleaner is secured in the cradle.

### OBJECTS OF THE INVENTION

It is, therefore, one of the primary objects of the present invention to provide a vacuum cleaning system for a motor vehicle.

Another object of the present invention is to provide a vacuum cleaning system for a motor vehicle which enables ease of cleaning interior cabin and cargo areas.

Yet another object of the present invention is to provide a vacuum cleaning system for a motor vehicle which enables ease of use external to the vehicle confines.

A further object of the present invention is to provide a vacuum cleaning system for a motor vehicle which operates directly from the vehicle battery.

Yet a further object of the present invention is to provide a vacuum cleaning system for a motor vehicle which enables convenient storage of the hose and cleaning tools.

An additional object of the present invention is to provide a vacuum cleaning system for a motor vehicle which incorporates simple operating controls.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a partial schematic view of a motor vehicle particularly illustrating a vacuum cleaning system of the present invention;

FIG. 2 is an elevation view, partially in cross-section, of the inlet port of one embodiment;

FIG. 3 is an elevation view, partially in cross-section, of the inlet port of another embodiment;

FIG. 4 is a schematic elevation view of a suction generating assembly of one embodiment of the invention; and

FIG. 5 is a schematic elevation view of a suction generating assembly of another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a cargo area applies to a trunk in a sedan or a coupe motor vehicle and the like and a rear cargo space in hatchbacks, sport utility vehicles, minivans, vans and the like.

Reference is now made, to FIG. 1, wherein there is shown a motor vehicle of a sedan type and the like, generally designated 10, including a cargo area 12 with a floor member 14 and a side wall 16 and an interior passenger cabin 20 having a floor member 22, a rear seat 24 and a rear seat support frame 26. A bulkhead 30 separates cargo area 12 from the interior passenger cabin 20.

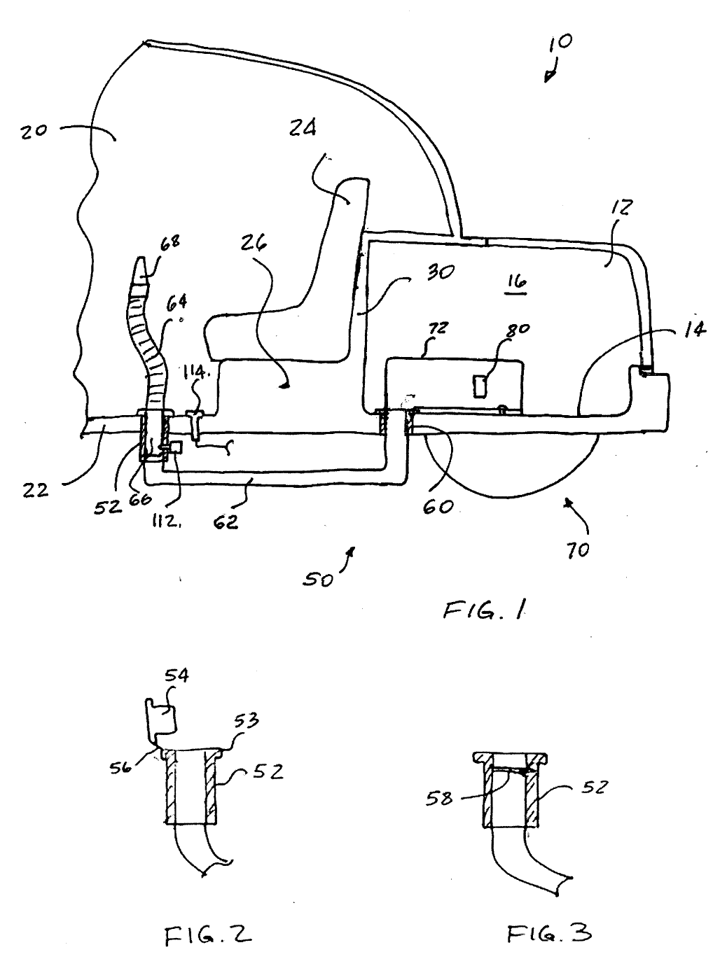

The vacuum cleaning system, generally designated 50, is shown in FIGS. 1-5. Such vacuum cleaning system 50 includes an inlet port 52 rigidly attached to a predetermined portion of an interior passenger cabin 20 of such vehicle 10. Preferably, such predetermined portion is the floor member 22 adjacent the rear seat 24. In particular reference to FIG. 2, inlet port 52 may be provided with a cover means 54 secured to a flange 53 thereof with a flexible strap 56 and which is manually operable for closing the inlet port 52 when the vacuum cleaning system 50 is not in use. Alternatively, as shown in FIG. 3, inlet port 52 may be adapted with an internally disposed flexible membrane 58 which is movable between a first position for closing such inlet port 52 and a second position for opening inlet port 52. The flexible membrane 58 is disposed in such first position when the vacuum cleaning system 50 is not in use and returns into such first position when the first end 66 of the flexible hose 64 is removed from the inlet port 52.

An outlet port 60 is rigidly attached to a predetermined portion of the cargo area 12, which is preferably the floor member 14.

An air and debris communication means 62 connects inlet port 52 with outlet port 60. Such air and debris communication means 62 may be one of a flexible hose, rigid conduit and combination thereof. It would be appreciated that a flexible hose may be advantageous in retrofitting existing motor vehicles with the vacuum cleaning system 50 of the present invention, while the rigid conduit may be provided in a newly manufactured motor vehicle 10.

It will be appreciated that inlet port 52 is used for direct and removable engagement with a first end 66 of a flexible hose 64. The second end 68 of flexible hose 64 is used for attaching various cleaning tools (not shown) which are well known in the art.

A suction generating assembly of one embodiment, generally designated 70, is best shown in FIGS. 1 and 4. Such suction generating assembly 70 is preferably disposed within a cargo area 12 of such vehicle 10 and includes a housing 72 having means for attachment, such as apertures 74, to a predetermined surface portion of the cargo area 12. An intake means 76, such as an aperture 76 in combination with the cavity 77, is aligned with the outlet port 62 and may be provided with a gasket 78 attached to the exterior surface of the housing 72 and surrounding such aperture 76. Alternatively, such gasket 78 may be attached to the outlet port 60.

An exhaust means 80, such as at least one aperture 80, is disposed on an outer surface of the housing 12. A passageway 82 connects intake means 76 with the exhaust means 80.

A waste collection container 90 is removably disposed within housing 72 intermediate the intake and exhaust means 76 and 80, respectively, and at least partially incorporates such passage way 82. The waste collection container 90 may be provided with a grip means, such as a handle 92 for ease of removing and inserting such waste collection container 90. An exposed outer surface of the waste collection container forms a portion of the exterior surface of the housing 72. Alternatively, the waste collection container 90 may be disposed beyond a cover (not shown) provided in the portion of the housing 72.

A fan assembly 100 is disposed within the housing 72 adjacent exhaust means 80 for forming a vacuum in the passage way 82 and enabling suction of air and debris into the waste collection container 90 through the intake means 76. Preferably, exhaust means 80 is radially aligned with the impeller 100. An electric motor 102 is coupled to the fan assembly 100 for enabling rotation thereof when power is supplied to the electrical motor 102 from a power source. A wiring means 104 connects the electric motor 102 to a power source, which is one of a rechargeable battery 106 disposed within the housing 72, well known battery (not shown) of such vehicle 10 and combination thereof.

A filter member 108 is disposed intermediate the fan assembly 100 and the intake means 76 for separating the debris from the air, whereby at least a portion of the debris is accumulated in the waste collection container 90. Preferably, the filter member 108 is removably received within the waste collection container 90 for ease of cleaning when the waste collection container 90 is removed from the housing 72. Alternatively, such filter member 108 may be attached to an internal portion of the housing 72 and removed after removal of the waste collection container 90.

The vacuum cleaning system 50 further includes a control means for supplying power to the electric motor 102 of the suction generating assembly 70. In one embodiment of the invention, shown in FIG. 4, the control means is a switch 110 manually operable from the exterior portion of the housing 72. In another embodiment of the invention, shown in FIG. 1, the control means is a switch 112 disposed within a wall surface of the inlet port 52 and operable by engagement and disengagement of the first end 66 of the flexible hose 64. In yet another embodiment of the invention, best shown in FIG. 1, the control means is a manually operable switch 114 disposed in the predetermined portion of such interior passenger cabin 20, preferably adjacent inlet port 52.

It will be apparent to those skilled in the art that the inlet port 52 provides for convenience in vacuum cleaning of the interior passenger cabin 20 of the vehicle 10.

Advantageously, a second inlet port 120 is provided for convenience in vacuum cleaning of the cargo area 12 of the vehicle 10. Preferably, such second inlet port 120 is disposed within the housing 72 adjacent the intake means 76 and in communication with the cavity 77 and may be adapted with the cover 54 or the membrane 58 for use when the vacuum cleaning system 50 is not in use or during vacuum cleaning of the interior passenger cabin 20. Accordingly, such second inlet port 120 may be provided with the switch 112.

The housing 72 may be further provided with at least partially closed compartment 79 for storing the flexible hose 64 and various cleaning tools (not shown).

Installation of the vacuum cleaning system 50 of the present invention in the existing vehicle 10 simply will require forming of apertures in the cargo area 12 and the interior passenger cabin 20 for attachment of the inlet port 52 and the outlet port 60, installation of the suction generating assembly 70 in the cargo area and electrical connection to a battery source (not shown) of the vehicle 10.

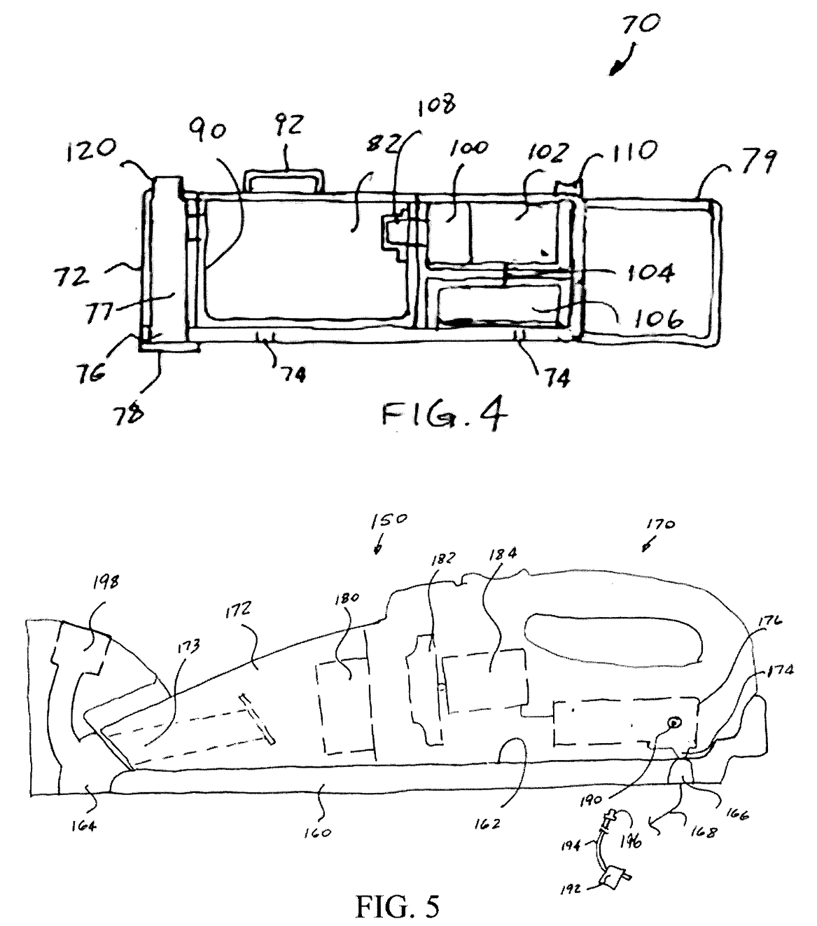

A suction generating assembly of another embodiment, generally designated 150, is best shown in FIG. 5. Such suction generating assembly 150 includes a base member 160 attached to a predetermined surface portion of a cargo area 12 of vehicle 10. The base member 160 has a cradle 162 having a predetermined shape, an intake means 164 disposed at one end of the cradle 162 and aligned with the outlet port 60 and at least one first electrical contact 166 having a wiring connection 168 to the battery source (not shown) of such vehicle 10.

A rechargeable cordless vacuum cleaner, generally designated 170, is at least partially secured and removably received in the cradle 162. Such rechargeable cordless vacuum cleaner 170 has a nozzle 172 with a suction end 173 securely received by the intake means 164 of the base member 160 and at least one second electrical contact 174 cooperating with the at least one first electrical contact 166 for recharging a rechargeable battery 176 of the rechargeable cordless vacuum cleaner 170 when it is secured in the cradle 162.

The rechargeable cordless vacuum cleaner 170 may be of any well known type characterized by a removable filter 180 disposed in the nozzle 172, a fan assembly 182 and an electric motor 184.

A means 190, such as a well known DC jack, is electrically coupled to the rechargeable battery 176 for recharging it from the electrical outlet (not shown) through a transformer 192 and a cable 194 with the male jack 196. Such adapter 190 will enable recharging of the rechargeable cordless vacuum cleaner 170 without using the battery source (not shown) of the vehicle 10. Alternatively, such means 190 may be disposed within the base member 160.

It will be appreciated that rechargeable cordless vacuum cleaner 170 may be used external to the confines of vehicle 10.

The suction end 173 of the nozzle 172 may be of any predetermined shape and size, but preferably, the shape and size of such suction end 173 is substantially identical to the shape and the size of the second end 68 of the flexible hose 64 for securely receiving various cleaning tools (not shown).

Advantageously, a second inlet 198 may be disposed within the base member 160 in cooperation with the intake means 164 for using the flexible hose 64 in the cargo area 12.

Furthermore, the base member 160 may be provided with at least a partially enclosed compartment (not shown) for storing the flexible hose 64 and various cleaning tools (not shown).

Those skilled in the art will readily understand that the vacuum cleaning system 50 of the present invention may simply comprise such base member 160 absent the intake means 162 and such rechargeable cordless vacuum cleaner 170, whereby the later will be utilized for cleaning the cargo area 12 and the interior passenger cabin 20 while eliminating the need for a flexible hose 64 and inlet and outlet ports 52 and 60, respectively.

Although the present invention has been shown in terms of the flexible hose inlet 52 being disposed in the floor member 22 of the interior passenger cabin 20, it will be apparent to those skilled in the art, that the present invention may be applied to other locations housing such flexible hose inlet 52. For example, it may be located in the vertical wall of the rear seat support structure 26 or within the bulkhead 30.

Furthermore, the air and debris communication means 62 may be routed through the side panel or floor structure of the vehicle 10.

Additionally, a recess cavity may be formed in the floor member 14 or the side wall 16 of the cargo area 12 for receiving the suction generating means of the invention.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A vacuum cleaning system for a vehicle, said vacuum cleaning system comprising:
(a) an inlet port disposed in a predetermined portion of an interior passenger cabin of such vehicle;
(b) an outlet port disposed in a predetermined portion of a cargo area of such vehicle;
(c) an air and debris communication means connecting said inlet port with said outlet port;
(d) a suction generating assembly disposed within such cargo area of such vehicle, said suction generating assembly including a housing having means for attachment to a predetermined surface portion of such cargo area, an intake means aligned with said outlet port, an exhaust means disposed on an outer surface of said housing, a passage way connecting said intake means with said exhaust means and a waste collection container removably disposed within said housing intermediate said intake and said exhaust means; and
(e) a flexible hose having a first end for removable and direct engagement with said inlet port and an opposed second end.

2. The system, according to claim 1, wherein said suction generating assembly further includes:
(a) a fan assembly disposed within said housing adjacent said exhaust means for forming a vacuum in said passage way and enabling suction of air and debris into said housing;
(b) an electric motor coupled to said fan assembly for enabling rotation thereof when power is supplied to said electrical motor; and
(c) a wiring means connecting said electric motor to a power source for supplying said power.

3. The system, according to claim 2, wherein said suction generating assembly further includes a filter assembly disposed intermediate said fan assembly and said intake means for separating said debris from said air, whereby at least a portion of said debris is accumulated in said waste collection container.

4. The system, according to claim 2, wherein said power source is one of a rechargeable battery disposed within said housing, battery of such vehicle and combination thereof.

5. The system, according to claim 2, wherein said vacuum cleaning system includes a control means for enabling power supply to said electric motor of said suction generating assembly.

6. The system, according to claim 5, wherein said control means is a switch manually operable from an exterior portion of said housing.

7. The system, according to claim 5, wherein said control means is a switch disposed within a wall surface of said inlet port and operable by engagement and disengagement of said first end of said flexible hose.

8. The system, according to claim 5, wherein said control means is a manually operable switch disposed in said predetermined portion of such interior passenger cabin adjacent said inlet port.

9. The system, according to claim 1, wherein said vacuum cleaning system further includes a second inlet port disposed adjacent said intake means of said housing for convenient use of said flexible hose in vacuum cleaning such cargo area.

10. The system, according to claim 1, wherein said vacuum cleaning system further includes a cover means for closing said inlet port.

11. The system, according to claim 10, wherein said cover means is manually operable to cover said inlet port.

12. The system, according to claim 11, wherein said cover means is a membrane disposed within said inlet port in a first position for closing said inlet port, said membrane movable into a second position by said first end of said flexible hose for allowing air and debris to flow through said inlet port, said flexible membrane returning into said first position when said first end of said flexible house is removed from said inlet port.

13. The system, according to claim 1, wherein said air and debris communication means is one of a flexible hose, rigid conduit and combination thereof.

14. The system, according to claim 1, wherein said vacuum cleaning system further includes means engageable with said housing for storing said flexible hose and said cleaning tools.

15. A vacuum cleaning system for a vehicle, said vacuum cleaning system comprising:
(a) an inlet port disposed in a predetermined portion of an interior passenger cabin of such vehicle;
(b) an outlet port disposed in a predetermined portion of a cargo area of such vehicle;
(c) an air and debris communication means connecting said inlet port with said outlet port;
(d) a base member attached to a predetermined surface portion of such cargo area of such vehicle, said base member having a cradle, an intake means disposed at one end of said cradle and aligned with said outlet port and at least one first electrical contact connected to a battery source of such vehicle;
(e) a rechargeable cordless vacuum cleaner at least partially secured and removably received in said cradle, said rechargeable cordless vacuum cleaner having a nozzle with a suction end securely received by said intake means of said base member and at least one second electrical contact cooperating with said at least one first electrical contact to recharge a rechargeable battery of said cleaner when said rechargeable cordless vacuum cleaner is secured in said cradle, whereby said rechargeable cordless vacuum cleaner is operable for vacuum cleaning external to the vehicle confines; and
(f) a flexible hose having a first end for removable and direct engagement with said inlet port and an opposed second end.

16. The system, according to claim 15, wherein said rechargeable cordless vacuum cleaner includes means coupled to said at least one first electrical contact for recharging said rechargeable battery from an electrical outlet.

17. The system, according to claim 15, wherein said rechargeable cordless vacuum cleaner further includes a second inlet port disposed adjacent said intake means of said base member for convenient use of said flexible hose in vacuum cleaning such cargo area.

18. The system, according to claim 15, wherein a shape and size of said suction end of said nozzle is substantially identical to a shape and size of said second end of said flexible hose assembly.

19. A vacuum cleaning system for a vehicle, said vacuum cleaning system comprising:
(a) a base member attached to a predetermined surface portion of such cargo area of such vehicle, said base member having a cradle and at least one first electrical contact connected to a battery source of such vehicle; and
(b) a rechargeable cordless vacuum cleaner at least partially secured and removably received in said cradle, said cleaner having a nozzle with a suction end and at least one second electrical contact cooperating with said at least one first electrical contact to recharge a rechargeable battery of said rechargeable cordless vacuum cleaner when said rechargeable cordless vacuum cleaner is secured in said cradle.
